(19) United States
(12) Patent Application Publication
(10) Pub. No.: US 2026/0143018 A1
(43) Pub. Date: May 21, 2026

(54) SYSTEM AND METHOD FOR CONNECTING ELECTRONIC DEVICES TO RICH COMMUNICATION SERVICE

(71) Applicant: Anthony NUZZO, Johnsburg, IL (US)

(72) Inventor: Anthony NUZZO, Johnsburg, IL (US)

(21) Appl. No.: 19/396,603

(22) Filed: Nov. 21, 2025

Related U.S. Application Data
(60) Provisional application No. 63/723,344, filed on Nov. 21, 2024.

(51) Int. Cl. H04L 65/1016; G06F 8/65; H04L 1/00; H04L 12/28

(52) U.S. Cl. CPC H04L 65/1016; H04L 1/0061; H04L 12/2803; G06F 8/65; H04L 2012/285

(57) ABSTRACT

A rich communication service (RCS) capable hardware device includes a memory storing computer-readable instructions and at least one processor to execute the instructions to receive a first message from a RCS capable computing device, parse the first message to determine content of the first message, determine at least one error code associated with content in the first message, and transmit a second message to an associated manufacturer, and receive a third message from the associated manufacturer in response to the second message and trigger an alert for the RCS capable hardware device in response to the at least one error code.

### CROSS-REFERENCE TO RELATED APPLICATION

This application claims the benefit of U.S. Provisional Application No. 63/723,344 filed Nov. 21, 2024, entitled “SYSTEM AND METHOD FOR CONNECTING ELECTRONIC DEVICES TO RICH COMMUNICATION SERVICE,” the entire contents of which is incorporated herein by reference.

### BACKGROUND

Many electronic devices that are not smartphones (e.g., refrigerators, printers, pool heaters, air conditioners, etc.) currently lack a way to communicate issues or maintenance needs to users or service providers. Traditional network solutions for these devices, such as connecting printers on a local area network (LAN) to the internet, involve publishing the electronic device's TCP/IP address, which exposes the network to potential unauthorized access. This approach raises security concerns, such as the risk of unauthorized access to documents or data stored on a device's hard drive.

It is with these issues in mind, among others, that various aspects of the disclosure were conceived.

### SUMMARY

The present disclosure is directed to a system and method for connecting electronic devices to rich communication service (RCS). A system may include one or more electronic devices such as an appliance and a client computing device that communicates with a server computing device. In one example, the client computing device may send a first message to the appliance and to the server computing device that may indicate a potential issue with the appliance. The appliance may receive the first message and send a second message to the server computing device that includes information associated with the appliance. The server computing device may send a third message to the appliance to trigger an update for the appliance that can address the potential issue with the appliance. In addition, the server computing device may send a fourth message to the client computing device that provides information regarding the appliance, e.g., the appliance is now functioning and any issues have been addressed or resolved.

In one example, an RCS capable hardware device may include a memory storing computer-readable instructions and at least one processor to execute the instructions to receive a first message from a RCS capable computing device, parse the first message to determine content of the first message, determine at least one error code associated with content in the first message, and transmit a second message to an associated manufacturer, and receive a third message from the associated manufacturer in response to the second message and trigger an alert for the RCS capable hardware device in response to the at least one error code.

In another example, a method performed by an RCS capable hardware device may include receiving, by at least one processor, a first message from a RCS capable computing device, parsing, by the at least one processor, the first message to determine content of the first message, determining at least one error code associated with content in the first message, and transmitting a second message to an associated manufacturer, and receiving, by the at least one processor, a third message from the associated manufacturer in response to the second message and triggering an alert for the RCS capable hardware device in response to the at least one error code.

In another example, a non-transitory computer-readable storage medium includes instructions stored thereon that, when executed by an RCS capable hardware device cause the RCS capable hardware device to perform operations, the operations including receiving a first message from a RCS capable computing device, parsing the first message to determine content of the first message, determining at least one error code associated with content in the first message, and transmitting a second message to an associated manufacturer, and receiving a third message from the associated manufacturer in response to the second message and triggering an alert for the RCS capable hardware device in response to the at least one error code.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a system for connecting electronic devices to rich communication service (RCS) according to an example of the instant disclosure.

FIG. 2 is another block diagram of the system for connecting electronic devices to RCS according to an example of the instant disclosure.

FIG. 3 is another block diagram of the system for connecting electronic devices to RCS according to an example of the instant disclosure.

FIG. 4 is a flowchart of a method of triggering an alert for an RCS capable hardware device in response to an at least one error code according to an example of the instant disclosure.

FIG. 5 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a system and method for connecting electronic devices to rich communication service (RCS) includes one or more electronic devices such as appliances and a client computing device that communicates with a server computing device. In one example, the client computing device may send a first message to the appliance and to the server computing device that may indicate a potential issue with the appliance. The appliance may receive the first message and send a second message to the server computing device that includes information associated with the appliance. The server computing device may send a third message to the appliance to trigger an update for the appliance that can address the potential issue with the appliance. In addition, the server computing device may send a fourth message to the client computing device that provides information regarding the appliance, e.g., the appliance is now functioning and any issues have been addressed or resolved.

Many electronic devices that are not smartphones (e.g., refrigerators, printers, pool heaters, air conditioners, etc.) currently lack a way to communicate issues or maintenance needs to users or service providers. Traditional network solutions for these devices, such as connecting printers on a local area network (LAN) to the internet, involve publishing the device's TCP/IP address, which exposes the network to potential unauthorized access. This approach raises security concerns, such as the risk of unauthorized access to documents or data stored on a device's hard drive.

The system solves security concerns by enabling these electronic devices to communicate using RCS (Rich Communication Service) without using a published TCP/IP address, improving security and convenience for users. Each electronic device could have its own mobile number that can be shared with applications and people outside of a corporate network.

The system can use RCS by assigning an iSIM (integrated subscriber identity module (SIM)), pSIM (physical SIM), or eSIM (embedded SIM) along with a registered mobile number to an electronic device. This approach avoids publishing the device's TCP/IP address, and uses the assigned mobile number to send and receive RCS messages. Through the RCS protocol, the electronic device can send outbound notifications to users, such as alerting them to issues like “water filter needs replacement.” Inbound commands, such as software updates or reset instructions, can also be sent back to the electronic device over RCS.

When an electronic device, such as a refrigerator or printer, etc., is purchased, the electronic device may include an iSIM/pSIM/eSIM or the ability to add an eSIM, and register a mobile number just like a mobile phone. Using RCS, the electronic device can participate in group messages that may include the electronic device owner, the manufacturer, and service personnel, among others. For instance, the owner could send a group message to the manufacturer and the electronic device asking, “Why is my refrigerator not making ice?” The manufacturer, using the mobile number associated with the device, could automatically or manually respond with troubleshooting guidance, such as suggesting a water filter replacement. Furthermore, the electronic device could return error codes via RCS, allowing for a more precise diagnosis. To address one or more issues, fixes, or patches can be sent as binary files over RCS to update the electronic device's firmware, middleware, or software.

As an example, the RCS capable hardware device may be any electronic device with an iSIM/pSIM/eSIM connected to a computer network capable of communicating with users and service providers via RCS without using a published TCP/IP address.

As another example, a method for connecting electronic devices notifies users and manufacturers of device status and maintenance needs via RCS, using outbound alerts and inbound troubleshooting or updates.

In another example, the system allows non-communicative devices to utilize RCS for remote troubleshooting, diagnostics, and preventative maintenance updates by interfacing with automated systems and user applications.

As another example, the system allows tracing of stolen goods using the built in location services of the mobile network operators to determine a location of an RCS capable hardware device.

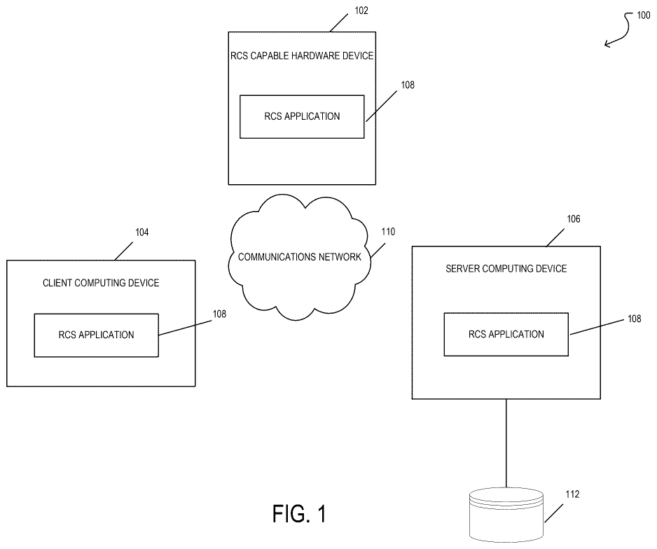

FIG. 1 is a block diagram of a system for connecting electronic devices to rich communication service (RCS) 100 according to an example of the instant disclosure. As shown in FIG. 1, the system 100 may include one or more RCS capable hardware devices 102, one or more client computing devices 104, e.g., RCS capable computing devices, and one or more server computing devices 106. The at least one server computing device 106 may be in communication with at least one database 112. In one example, the RCS capable hardware device 102 may be one of a refrigerator, a freezer, a microwave, a dishwasher, a printer, a washing machine, a dryer, a pool heater, a pool filter, an air conditioner, a heat pump, a water heater, and a furnace, among others. The RCS capable hardware device 102 may include one of an eSIM, iSIM, and pSIM to communicate with the client computing device 104 and the server computing device 106, among other computing devices.

The RCS capable hardware device 102, the client computing device 104, and the server computing device 106 may have an RCS application 108 that may be a component of an application and/or service executable by the at least one RCS capable hardware device 102, the client computing device 104, and/or the server computing device 106. For example, the RCS application 108 may be a single unit of deployable executable code or a plurality of units of deployable executable code. According to one aspect, the RCS application 108 may include one component that may be a web application, a native application, and/or a mobile application (e.g., an app) downloaded from a digital distribution application platform that allows users to browse and download applications developed with mobile software development kits (SDKs) including the App Store and GOOGLE PLAY®, among others.

The system 100 also may include a relational database management system (RDBMS) or another type of database management system such as a NoSQL database system that stores and communicates data from at least one database 112. The data stored in the at least one database 112 may be associated with the one or more RCS capable hardware devices 102 and may include information that may be parsed in response to received messages such as error codes and associated potential solutions for each error code.

The RCS capable hardware device 102, the at least one client computing device 104, and the at least one server computing device 106 may be configured to receive data from and/or transmit data through a communication network 110. Although the RCS capable hardware device 102, the client computing device 104, and the server computing device 106 are shown as a single computing device, it is contemplated each computing device may include multiple computing devices.

The communication network 110 can be the Internet, an intranet, or another wired or wireless communication network. For example, the communication network may include a code division multiple access (CDMA) network, 3^{rd} Generation Partnership Project (3GPP) network such as a Global System for Mobile Communications (GSM) network, Universal Mobile Telecommunications System (UTMS) network, Long Term Evolution (LTE) network, or Fifth Generation (5G) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The RCS capable hardware device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the RCS capable hardware device 102 further includes at least one communications interface to transmit and receive communications, messages, and/or signals.

The RCS capable hardware device 102 could be a programmable logic controller, a programmable controller, a laptop computer, a smartphone, a personal digital assistant, a tablet computer, a standard personal computer, or another processing device. The RCS capable hardware device 102 may include a display, such as a computer monitor, for displaying data and/or graphical user interfaces. The RCS capable hardware device 102 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The client computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 104 further includes at least one communications interface to transmit and receive communications, messages, and/or signals.

The client computing device 104 could be a programmable logic controller, a programmable controller, a laptop computer, a smartphone, a personal digital assistant, a tablet computer, a standard personal computer, or another processing device. The client computing device 104 may include a display, such as a computer monitor, for displaying data and/or graphical user interfaces. The client computing device 104 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 106 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 106 further includes at least one communications interface to transmit and receive communications, messages, and/or signals.

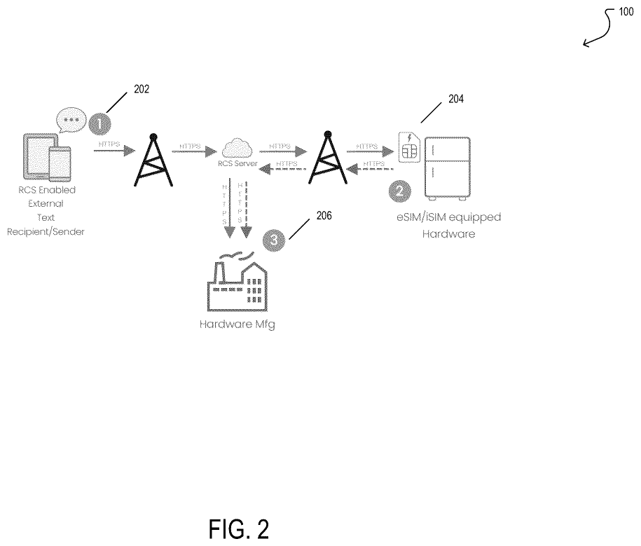

FIG. 2 is another block diagram of the system 100 for connecting electronic devices to RCS according to an example of the instant disclosure. FIG. 2 shows a device network communication model according to an example of the instant disclosure.

As shown in FIG. 2, in 202, the client computing device 104 sends a group ‘text’ message to the RCS capable hardware device 102 and/or the server computing device 106 that may be associated with a manufacturer at pre-determined phone numbers. The eSIM/iSIM/pSIM is attached to the RCS capable hardware device 102 (e.g., refrigerator in this example). The message is secure (https throughout) and contains RCS-enabled content. This content triggers the RCS capable hardware device 102 to send a command back to the server computing device 106 of the manufacturer.

In 204, the RCS capable hardware device 102 (e.g., refrigerator) receives the RCS-enabled content, parses the content, and sends an RCS message in response via “text” to the server computing device 106 at the manufacturer.

In 206, the server computing device 106 at the manufacturer receives the messages from the client computing device 104 and the RCS capable hardware device 102, which can be formatted according to the RCS protocol, and can contain far more ‘rich’ data from the RCS capable hardware device 102, and can be used for troubleshooting with the user, even while on a call. As a result, the server computing device 106 can respond to RCS capable hardware device 102 to trigger configuration or other changes as well.

As an example, FIG. 2 shows the hardware device 102 (e.g., refrigerator) equipped with an iSIM/pSIM/eSIM and associated mobile number, connecting to the internet via RCS without publishing the TCP/IP address of the device. In addition, FIG. 2 shows communication to a mobile phone, e.g., the client computing device 104, and the manufacturer's system e.g., the server computing device 106, highlighting secure outbound and inbound communication.

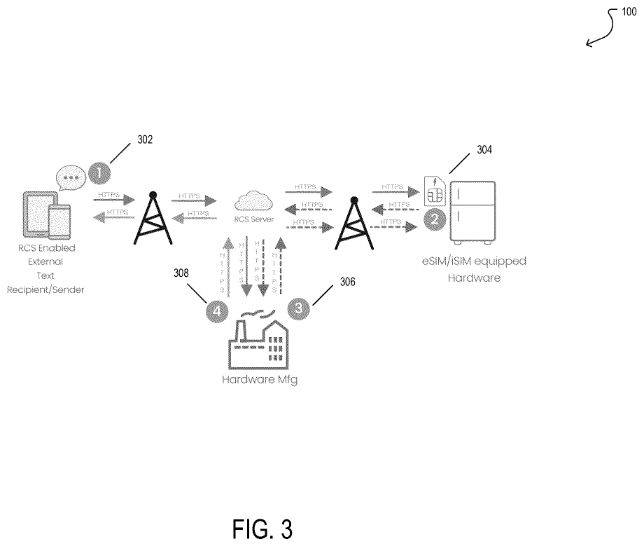

FIG. 3 is another block diagram of the system 100 for connecting electronic devices to RCS according to an example of the instant disclosure. FIG. 3 also shows an example RCS communication workflow.

FIG. 3 shows a group RCS message between the client computing device 104, the RCS capable hardware device 102, and server computing device 106 of the manufacturer. FIG. 3 shows sample messages such as an error alert from the RCS-capable hardware device 102, a troubleshooting response from the server computing device 106 of the manufacturer, and firmware update commands.

As an example, in 302, the client computing device 104 sends a group ‘text’ message to the RCS capable hardware device 102 and the server computing device 106 of the manufacturer at pre-determined phone numbers. The eSIM/iSIM/pSIM is attached to the hardware device 102 (e.g., refrigerator in this example). This message is secure (https throughout) and may include RCS-enabled content. A sample of the message may be: “Fridge is stuck in error code 015 with a flashing red light. I cannot find that error in the guide and don't know how to resolve it.”

In 304, the RCS capable hardware device 102 (e.g., refrigerator) receives the RCS-enabled content, parses the message, and determines that the message is related to an error code and sends an RCS message in response via “text” to the server computing device 106 at the manufacturer. This response will provide the manufacturer with details. Sample message: “ec\hat{ }015{cool\hat{ }44.5,do\hat{ }0,pu 7.224,ix\hat{ }.002}{diagnostics s:78B62155200927X1,m:GXJ557Y,17.3,22.9,16.24,.0056}”

In 306, the server computing device 106 of the manufacturer receives the messages, which can be formatted according to the RCS protocol, and may include ‘rich’ data from the hardware device 102 and allow a user to troubleshoot even while on a call with the client computing device 104. As a result, the server computing device 106 communicates on behalf of the manufacturer to the RCS enabled electronic device 102 to trigger configuration or other changes as well. As an example, a message response to fix can be: “set:ec\hat{ }15{cool\hat{ }42.3,do\hat{ }0,pu\hat{ }6.24,ix\hat{ }1.0,<restart>} which would trigger a configuration update and restart of the refrigerator in this example. In addition, this may clear the error and resolve the issue for the user.

In 308, the server computing device 106 of the manufacturer can respond to the client computing device 104 of the user with a notification that the error has been cleared and check the refrigerator 102 to ensure it is back to working order.

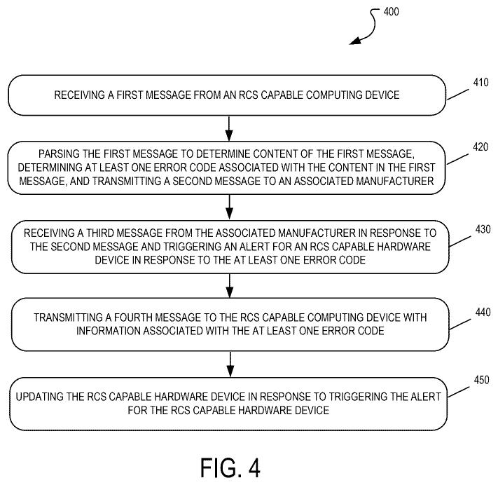

FIG. 4 illustrates an example method 400 of triggering an alert for an RCS capable hardware device 102 in response to at least one error code according to an example of the instant disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 may be performed by an RCS capable hardware device 102 and include receiving a first message from an RCS capable computing device 104 at block 210. As an example, the RCS capable hardware device 102 may include at least one of an eSIM, iSIM, and pSIM. In one example, the RCS capable hardware device 102 may be one of a refrigerator, a freezer, a microwave, a dishwasher, a printer, a washing machine, a dryer, a pool heater, a pool filter, an air conditioner, a heat pump, a water heater, and a furnace, among others.

Next, according to some examples, the method 400 may include parsing the first message to determine content of the first message and determining at least one error code associated with the content in the first message and transmitting a second message to a server computing device 106 of the manufacturer at block 220.

Next, according to some examples, the method 400 may include receiving a third message from the server computing device 106 of the manufacturer in response to the second message and triggering an alert for the RCS capable hardware device 102 in response to the at least one error code at block 430.

Next, according to some examples, the method 400 may include transmitting a fourth message to the RCS capable computing device 104 with information associated with the at least one error code at block 440. As an example, the information can indicate that an error associated with the at least one error code is addressed.

Next, according to some examples, the method 400 may include updating the RCS capable hardware device 102 in response to triggering the alert for the RCS capable hardware device 102 at block 450.

In some examples, the method 400 may include sending the first message to the server computing device 106 of the associated manufacturer from the RCS capable hardware device 102 or the RCS capable computing device 104.

In some examples, the method 400 may include upon receipt of the third message, the RCS capable hardware device 102 downloads an update for the RCS capable hardware device 102 to address the at least one error code. The RCS capable hardware device 102 may install the update and restart the RCS capable hardware device 102.

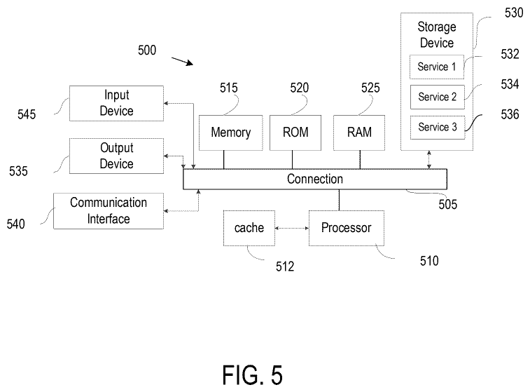

FIG. 5 shows an example of computing system 500, which can be for example any computing device making up the computing device such as the RCS capable hardware device 102, the client computing device 104, the server computing device 106, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A rich communication service (RCS) capable hardware device including a memory storing computer-readable instructions and at least one processor to execute the instructions to receive a first message from a RCS capable computing device, parse the first message to determine content of the first message, determine at least one error code associated with content in the first message, and transmit a second message to an associated manufacturer, and receive a third message from the associated manufacturer in response to the second message and trigger an alert for the RCS capable hardware device in response to the at least one error code.

Aspect 2: The RCS capable hardware device of Aspect 1, wherein the first message is sent to a server computing device of the associated manufacturer and the server computing device receives the second message from the RCS capable hardware device.

Aspect 3: The RCS capable hardware device of Aspects 1 and 2, wherein a fourth message is transmitted to the RCS capable computing device with information associated with the at least one error code.

Aspect 4: The RCS capable hardware device of Aspects 1 to 3, wherein the information indicates that an error associated with the at least one error code is addressed.

Aspect 5: The RCS capable hardware device of Aspects 1 to 4, wherein the RCS capable hardware device comprises at least one of an eSIM, iSIM, and pSIM.

Aspect 6: The RCS capable hardware device of Aspects 1 to 5, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

Aspect 7: The RCS capable hardware device of Aspects 1 to 6, wherein upon receipt of the third message, the RCS capable hardware device downloads an update for the RCS capable hardware device to address the at least one error code.

Aspect 8: The RCS capable hardware device of Aspects 1 to 7, wherein the RCS capable computing device comprises a client computing device.

Aspect 9: A method performed by an RCS capable hardware device includes receiving, by at least one processor, a first message from a RCS capable computing device, parsing, by the at least one processor, the first message to determine content of the first message, determining at least one error code associated with content in the first message, and transmitting a second message to an associated manufacturer, and receiving, by the at least one processor, a third message from the associated manufacturer in response to the second message and triggering an alert for the RCS capable hardware device in response to the at least one error code.

Aspect 10: The method of Aspect 9, wherein the first message is sent to a server computing device of the associated manufacturer and the server computing device receives the second message from the RCS capable hardware device.

Aspect 11: The method of Aspects 9 and 10, wherein a fourth message is transmitted to the RCS capable computing device with information associated with the at least one error code.

Aspect 12: The method of Aspects 9 to 11, wherein the information indicates that an error associated with the at least one error code is addressed.

Aspect 13: The method of Aspects 9 to 12, wherein the RCS capable hardware device comprises at least one of an eSIM, iSIM, and pSIM.

Aspect 14: The method of Aspects 9 to 13, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

Aspect 15: The method of Aspects 9 to 14, wherein upon receipt of the third message, the RCS capable hardware device downloads an update for the RCS capable hardware device to address the at least one error code.

Aspect 16: The method of Aspects 9 to 15, wherein the RCS capable computing device comprises a client computing device.

Aspect 17: A non-transitory computer-readable storage medium, having instructions stored thereon that, when executed by a RCS capable hardware device causes the RCS capable hardware device to perform operations, the operations including receiving a first message from a RCS capable computing device, parsing the first message to determine content of the first message, determining at least one error code associated with content in the first message, and transmitting a second message to an associated manufacturer, and receiving a third message from the associated manufacturer in response to the second message and triggering an alert for the RCS capable hardware device in response to the at least one error code.

Aspect 18: The non-transitory computer-readable storage medium of Aspect 17, wherein the first message is sent to a server computing device of the associated manufacturer, the operations further comprising transmitting the server computing device the second message.

Aspect 19: The non-transitory computer-readable storage medium of Aspects 17 and 18, wherein a fourth message is transmitted to the RCS capable computing device with information associated with the at least one error code.

Aspect 20: The non-transitory computer-readable storage medium of Aspects 17 to 19, wherein the information indicates that an error associated with the at least one error code is addressed.

Aspect 21: The non-transitory computer-readable storage medium of Aspects 17 to 20, wherein the RCS capable hardware device comprises at least one of an eSIM, iSIM, and pSIM.

Aspect 22: The non-transitory computer-readable storage medium of Aspects 17 to 21, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

Aspect 23: The non-transitory computer-readable storage medium of Aspects 17 to 22, wherein upon receipt of the third message, the RCS capable hardware device downloads an update for the RCS capable hardware device to address the at least one error code.

Aspect 24: The non-transitory computer-readable storage medium of Aspects 17 to 23, wherein the RCS capable computing device comprises a client computing device.

What is claimed is:

1. A rich communication service (RCS) capable hardware device comprising:
a memory storing computer-readable instructions; and
at least one processor to execute the instructions to:
receive a first message from a RCS capable computing device;
parse the first message to determine content of the first message, determine at least one error code associated with content in the first message, and transmit a second message to an associated manufacturer; and
receive a third message from the associated manufacturer in response to the second message and trigger an alert for the RCS capable hardware device in response to the at least one error code.

2. The RCS capable hardware device of claim 1, wherein the first message is sent to a server computing device of the associated manufacturer and the server computing device receives the second message from the RCS capable hardware device.

3. The RCS capable hardware device of claim 1, wherein a fourth message is transmitted to the RCS capable computing device with information associated with the at least one error code.

4. The RCS capable hardware device of claim 3, wherein the information indicates that an error associated with the at least one error code is addressed.

5. The RCS capable hardware device of claim 1, wherein the RCS capable hardware device comprises at least one of an eSIM, iSIM, and pSIM.

6. The RCS capable hardware device of claim 1, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

7. The RCS capable hardware device of claim 1, wherein upon receipt of the third message, the RCS capable hardware device downloads an update for the RCS capable hardware device to address the at least one error code.

8. The RCS capable hardware device of claim 1, wherein the RCS capable computing device comprises a client computing device.

9. A method performed by a rich communication service (RCS) capable hardware device, comprising:
receiving, by at least one processor, a first message from a RCS capable computing device;
parsing, by the at least one processor, the first message to determine content of the first message, determining at least one error code associated with content in the first message, and transmitting a second message to an associated manufacturer; and
receiving, by the at least one processor, a third message from the associated manufacturer in response to the second message and triggering an alert for the RCS capable hardware device in response to the at least one error code.

10. The method of claim 9, wherein the first message is sent to a server computing device of the associated manufacturer and the server computing device receives the second message from the RCS capable hardware device.

11. The method of claim 9, wherein a fourth message is transmitted to the RCS capable computing device with information associated with the at least one error code.

12. The method of claim 11, wherein the information indicates that an error associated with the at least one error code is addressed.

13. The method of claim 9, wherein the RCS capable hardware device comprises at least one of an eSIM, iSIM, and pSIM.

14. The method of claim 9, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

15. The method of claim 9, wherein upon receipt of the third message, the RCS capable hardware device downloads an update for the RCS capable hardware device to address the at least one error code.

16. The method of claim 9, wherein the RCS capable computing device comprises a client computing device.

17. A non-transitory computer-readable storage medium, having instructions stored thereon that, when executed by a rich communication service (RCS) capable hardware device cause the RCS capable hardware device to perform operations, the operations comprising:
receiving a first message from a RCS capable computing device;
parsing the first message to determine content of the first message, determining at least one error code associated with content in the first message, and transmitting a second message to an associated manufacturer; and
receiving a third message from the associated manufacturer in response to the second message and triggering an alert for the RCS capable hardware device in response to the at least one error code.

18. The non-transitory computer-readable storage medium of claim 17, wherein the first message is sent to a server computing device of the associated manufacturer and the server computing device receives the second message from the RCS capable hardware device.

19. The non-transitory computer-readable storage medium of claim 17, wherein a fourth message is transmitted to the RCS capable computing device with information associated with the at least one error code.

20. The non-transitory computer-readable storage medium of claim 19, wherein the information indicates that an error associated with the at least one error code is addressed.

21. The non-transitory computer-readable storage medium of claim 17, wherein the RCS capable hardware device comprises at least one of an eSIM, iSIM, and pSIM.

22. The non-transitory computer-readable storage medium of claim 17, wherein the RCS capable hardware device comprises one of a refrigerator, a freezer, a microwave, a dishwasher, a printer, a washing machine, a dryer, a pool heater, a pool filter, an air conditioner, a heat pump, a water heater, and a furnace.

23. The non-transitory computer-readable storage medium of claim 17, wherein upon receipt of the third message, the RCS capable hardware device downloads an update for the RCS capable hardware device to address the at least one error code.

24. The non-transitory computer-readable storage medium of claim 17, wherein the RCS capable computing device comprises a client computing device.
